(19) United States
(12) Patent Application Publication
(10) Pub. No.: US 2016/0078269 A1
(43) Pub. Date: Mar. 17, 2016

(54) FINGERPRINT SENSOR WITH SYNC SIGNAL INPUT

(71) Applicant: FINGERPRINT CARDS AB, Goteborg (SE)

(72) Inventor: Hans Thörnblom, Kungsbacka (SE)

(73) Assignee: FINGERPRINT CARDS AB, Goteborg (SE)

(21) Appl. No.: 14/710,134

(22) Filed: May 12, 2015

(30) Foreign Application Priority Data
Sep. 15, 2014 (SE) 1451069-7

(51) Int. Cl. G06K 9/00

(52) U.S. Cl. CPC G06K 9/0002; G06K 9/00053; G06K 9/00087

(57) ABSTRACT

The present invention relates to a fingerprint sensor comprising a voltage supply interface for receiving a supply voltage; a sensor communication interface for providing the fingerprint pattern signal to external circuitry; a synchronization input for receiving a sync signal interpreted to correspond to a first logical state when the sensor ground potential is at the first potential and to a second logical state, different from the first logical state, when the sensor ground potential is at the second potential, and a plurality of sensing elements, each comprising a sensing structure. The sensing elements are configured such that the potential of the sensing structures follows the potential of the modulated fingerprint sensor ground potential, and the timing of the sampling of sensing signals from the sensing elements is based on perceived state transitions of the sync signal.

### FIELD OF THE INVENTION

The present invention relates to a fingerprint sensor, a fingerprint sensing system, and to a method of sensing a fingerprint pattern.

### BACKGROUND OF THE INVENTION

Various types of biometric systems are used more and more in order to provide for increased security and/or enhanced user convenience.

In particular, fingerprint sensing systems have been adopted in, for example, consumer electronic devices, thanks to their small form factor, high performance and user acceptance.

Among the various available fingerprint sensing principles (such as capacitive, optical, thermal etc), capacitive sensing is most commonly used, in particular in applications where size and power consumption are important issues.

All capacitive fingerprint sensors provide a measure indicative of the capacitance between several sensing structures and a finger placed on or moved across the surface of the fingerprint sensor.

Some capacitive fingerprint sensors passively read out the capacitance between the sensing structures and the finger. This, however, requires a relatively large capacitance between sensing structure and finger. Therefore such passive capacitive sensors are typically provided with a very thin protective layer covering the sensing structures, which makes such sensors rather sensitive to scratching and/or ESD (electro-static discharge).

U.S. Pat. No. 7,864,992 discloses a fingerprint sensing system in which a driving signal is injected into the finger by pulsing a conductive structure arranged in the vicinity of the sensor array and measuring the resulting change of the charge carried by the sensing structures in the sensor array.

According to another approach, disclosed US 2013/0271422, the fingerprint sensor chip ground potential is modulated in accordance with a clock signal generated by the fingerprint sensor chip, and communication with the sensor chip takes place via a level translator.

It would be desirable to provide for an alternative fingerprint sensing system with a modulated fingerprint sensor ground potential, which can be made with standard CMOS-technology to thereby enable a more cost-efficient solution.

### SUMMARY

In view of above-mentioned and other drawbacks of the prior art, it is an object of the present invention to provide an improved fingerprint sensor, that provides for a more cost-efficient fingerprint sensing system with a modulated fingerprint sensor reference potential.

According to a first aspect of the present invention, it is therefore provided a fingerprint sensor for sensing a fingerprint pattern of a finger and providing a fingerprint pattern signal indicative of the fingerprint pattern to external circuitry, the fingerprint sensor comprising: a voltage supply interface for receiving a supply voltage referenced to a time-varying sensor ground potential, the sensor ground potential varying between a relatively low first potential and a relatively high second potential in relation to a device ground potential being a reference potential for the external circuitry and for the finger; a sensor communication interface for receiving signals from the external circuitry and for providing the fingerprint pattern signal to the external circuitry; a synchronization input for receiving from the external circuitry a sync signal exhibiting a substantially constant sync signal potential, relative to the device ground, the sync signal potential being sufficiently close to the second potential to be interpreted by the fingerprint sensor to correspond to a first logical state when the sensor ground potential is at the first potential and to a second logical state, different from the first logical state, when the sensor ground potential is at the second potential; a plurality of sensing elements, each comprising: a protective dielectric top layer to be touched by the finger; an electrically conductive sensing structure arranged underneath the top layer; and a charge amplifier connected to the sensing structure for providing a sensing signal indicative of a change of a charge carried by the sensing structure resulting from a change in a potential difference between the finger and the sensing structure, the charge amplifier comprising: a negative input connected to the sensing structure; a positive input connected to a sensing element reference potential being substantially constant relative to the time-varying sensor ground potential; an output providing the sensing signal; a feedback capacitor connected between the negative input and the output; and at least one amplifier stage between the positive and negative inputs, and the output, wherein the charge amplifier is configured in such a way that a potential at the negative input substantially follows a potential at the positive input, such that the sensing element reference potential provides the change in potential difference between the finger and the sensing structure; and read-out circuitry connected to the synchronization input, and to the output of the charge amplifier of each of the sensing elements for sampling the sensing signal provided by each of the sensing elements at sampling times related to transitions, perceived by the fingerprint sensor, of the sync signal from the first logical state to the second logical state or from the second logical state to the first logical state, and forming the fingerprint pattern signal based on the sampled sensing signals.

The read-out circuitry may include circuitry for converting analog signals to digital signals. Such circuitry may include at least one analog to digital converter circuit. In such embodiments, the fingerprint sensor may thus provide the fingerprint pattern signal as a digital signal.

In embodiments, the relatively low first potential may be substantially equal to the device ground potential, and the relatively high second potential may be substantially equal to a supply voltage for which inputs/outputs (I/O:s) of the external circuitry are rated, such as 3.3 V or 1.8 V. In other embodiments, the relatively high second potential may be substantially equal to the device ground potential, and the relatively low first potential may be a negative potential (in relation to the device ground potential) of, for example, −3.3 V or −1.8 V etc.

The “first logical state” may be a logical low (or ‘0’) or a logical high (or 1′), and the “second logical state” may be the opposite, that is, a logical high (or 1′) or a logical low (or ‘0’).

The charge amplifier converts charge at the negative input to a voltage at the output. The gain of the charge amplifier is determined by the capacitance of the feedback capacitor.

That the charge amplifier is configured in such a way that the potential at the negative input substantially follows the potential at the positive input should be understood to mean that a change in the potential at the positive input results in a substantially corresponding change in the potential at the negative input. Depending on the actual configuration of the charge amplifier, the potential at the negative input may be substantially the same as the potential at the positive input, or there may be a substantially constant potential difference between the positive input and the negative input. If, for instance, the charge amplifier is configured as a single stage amplifier, the potential difference may be the gate-source voltage of the transistor of the single stage amplifier.

It should be noted that the output of the charge amplifier need not be directly connected to the feedback capacitor, and that there may be additional circuitry between the output and the feedback capacitor. This circuitry could also be placed outside the matrix of sensing elements.

The sensing structure may advantageously be provided in the form of a metal plate, so that a kind of parallel plate capacitor is formed by the sensing structure (the sensing plate), the local finger surface, and the protective coating (and any air that may locally exist between the local finger surface and the protective coating).

The protective coating may advantageously be at least 20 μm thick and have a high dielectric strength to protect the underlying structures of the fingerprint sensing device from wear and tear as well as ESD. Even more advantageously, the protective coating may be at least 50 μm thick. In embodiments, the protective coating may be a few hundred μm thick.

The present invention is based upon the realization that it would be desirable to provide for a fingerprint sensor with a modulated fingerprint sensor ground potential (in relation to an external device ground potential) without level shifters or other analog circuitry between the fingerprint sensor and other parts of an electronic device in which the fingerprint sensor is included.

The present inventor has further realized that this can be achieved by deciding the timing of the fingerprint sensing outside the fingerprint sensor, and synchronizing the operation of the fingerprint sensor using a sync signal that is interpreted by the fingerprint sensor to be in different logical states depending on the modulated (relative to the device ground potential) fingerprint sensor ground potential.

This means that no level shifter is needed to be able to interface with the fingerprint sensor. This in turn means that the external circuitry used for handling communication with the fingerprint sensor can be realized using standard digital processes with “normal” I/O:s. This at least provides for a reduced cost (and time) of development, since new versions of the external circuitry, maybe with added or improved functionality, can be produced at a relatively low cost and with a relatively short lead time.

According to various embodiments of the present invention, the sensor communication interface may advantageously comprise communication control circuitry connected to the synchronization input for enabling communication between the fingerprint sensor and the external circuitry through the sensor communication interface when the sync signal is interpreted by the fingerprint sensor to be in one of the first logical state and the second logical state corresponding to the sensor ground potential being substantially equal to the device ground potential; and preventing communication between the fingerprint sensor and the external circuitry through the sensor communication interface when the sync signal is interpreted by the fingerprint sensor to be in the other one of the first logical state and the second logical state, corresponding to the sensor ground potential deviating from the device ground potential.

Hereby, the sync signal can be used to ensure that communication between the fingerprint sensor and the external circuitry only takes place at times when the fingerprint sensor ground is substantially equal to the device ground potential. This ensures that signals are not interpreted incorrectly due to the modulated fingerprint sensor ground potential.

Furthermore, the communication circuitry may advantageously comprise at least one communication input for receiving signals from the external circuitry; and the communication control circuitry may comprise input gating circuitry connected to the communication input and to the synchronization input for preventing signals from the external circuitry provided to the communication input from passing the input gating circuitry when the sync signal is interpreted by the fingerprint sensor to be in one of the first logical state and the second logical state corresponding to the sensor ground potential deviating from the device ground potential. The at least one communication input may be at least one dedicated communication input.

Through the provision of input gating circuitry controlled by the sync signal, it can be ensured that signals from the external circuitry are not allowed to proceed past the input gating circuitry at times when the fingerprint sensor ground potential deviates from the device ground potential. At times when the fingerprint sensor ground potential is substantially equal to the device ground potential, signals from the external circuitry are allowed to proceed past the input gating circuitry.

The input gating circuitry may be any circuitry that is controllable to allow or prevent signals to pass the input gating circuitry based on the logical state (such as high or low) of the synch signal as interpreted by the fingerprint sensor. The input gating circuitry may, furthermore be directly connected to the synchronization input, or there may be additional circuitry between the synchronization input and the input gating circuitry. Depending on the actual implementation, the input gating circuitry may, for instance, be realized using a logical gate, a combination of logical gates (AND, OR, NAND, XOR, etc) or three-state logic.

If, for example, the fingerprint sensor ground potential is modulated between 0 V and +3.3 V in relation to the device ground potential, and the sync signal is kept constant at about +3.3 V in relation to the device ground potential, then the sync signal will be interpreted by the fingerprint sensor as a logical high (‘1’) when the fingerprint sensor ground potential is 0 V, and as a logical low (‘0’) when the fingerprint sensor ground potential is +3.3 V. In this case, any input signals should only be allowed to pass the input gating circuitry when the sync signal is a logical high (‘1’). This can, for instance, be achieved by configuring the input gating circuitry to perform a logical AND-operation on the sync signal and the signal at the communication input. For instance, the input gating circuitry may comprise an AND-gate.

According to various embodiments, furthermore, the communication circuitry may comprise at least one communication output for providing the fingerprint pattern signal to the external circuitry; and the communication control circuitry may comprise output gating circuitry connected to the read-out circuitry and to the synchronization input for providing, when the sync signal is interpreted by the fingerprint sensor to be in a logical state corresponding to the sensor ground potential deviating from the device ground potential, an output signal representing the logical state. The communication output may be a dedicated communication output.

Since the fingerprint sensor ground potential is modulated in relation to the device ground potential, signal levels in the fingerprint sensor may be so high (or low) in relation to the device ground potential, that the external circuitry could be damaged if it were subjected to such signal levels.

If, for example, the fingerprint sensor ground potential is modulated between 0 V and +3.3 V in relation to the device ground potential and the supply voltage to the fingerprint sensor is 3.3 V, then signal levels in the fingerprint sensor will vary over time between 0 V and +6.6 V in relation to the device ground potential. When, in this example, the fingerprint sensor ground potential is at +3.3 V in relation to the device ground potential, the communication output(s) of the fingerprint sensor should therefore be kept “low”, corresponding to +3.3 V in relation to the device ground potential.

In this first example, the sync signal may be kept at a substantially constant potential, in relation to the device ground potential, of about +3.3 V. This means that the sync signal will be interpreted by the fingerprint sensor as a logical low (or ‘0’) when the sensor ground potential deviates from the device ground potential.

By, in this example, ensuring that the output signal from the output gating circuitry is a logical low (the same as the sync signal) when the sensor ground potential deviates from the device ground potential, the potential at the communication output(s) of the fingerprint sensor will not exceed +3.3 V.

If, for example, the fingerprint sensor ground potential is modulated between −3.3 V and 0 V in relation to the device ground potential and the supply voltage to the fingerprint sensor is 3.3 V, then signal levels in the fingerprint sensor will vary over time between −3.3 V and +3.3 V in relation to the device ground potential. When, in this example, the fingerprint sensor ground potential is at −3.3 V in relation to the device ground potential, the communication output(s) of the fingerprint sensor should therefore be kept “high”, corresponding to 0 V in relation to the device ground potential.

In this second example, the sync signal may be kept at a substantially constant potential, in relation to the device ground potential, of about 0 V. This means that the sync signal will be interpreted by the fingerprint sensor as a logical high (or ‘1’) when the sensor ground potential deviates from the device ground potential.

By, in this example, ensuring that the output signal from the output gating circuitry is a logical high (the same as the sync signal) when the sensor ground potential deviates from the device ground potential, the potential at the communication output(s) of the fingerprint sensor will not be lower than 0 V.

The output gating circuitry may be any circuitry that is controllable to provide an output signal representing the logical state of the sync signal interpreted by the fingerprint sensor when the sensor ground potential deviates from the device ground potential.

The output gating circuitry may, furthermore be directly connected to the synchronization input, or there may be additional circuitry between the synchronization input and the output gating circuitry. Depending on the actual implementation, the output gating circuitry may, for instance, be realized using a logical gate, a combination of logical gates (AND, OR, NAND, XOR, etc) or three-state logic.

According to various embodiments, the fingerprint sensor may be an SPI (Serial Peripheral Interface) slave, and the sensor communication interface may be an SPI port comprising a serial clock input (SCLK); a master output slave input (MOSI), a slave select input (CS); and a master input slave output (MISO).

In such embodiments, the above-mentioned input gating circuitry may be implemented for the serial clock input, the master output slave input, and the slave select input, and the above-mentioned output gating circuitry may be implemented for the master input slave output.

According to various embodiments, moreover, the read-out circuitry may comprise sampling circuitry for sampling the sensing signals a first time when the sync signal is interpreted by the fingerprint sensor to be in one of the first logical state and the second logical state, and a second time when the sync signal is interpreted by the fingerprint sensor to be in the other one of the first logical state and the second logical state.

The procedure of sampling the sensing signal at first and second sampling times is generally referred to as correlated double sampling and removes much of the offset as well as at least low-frequency components of the common mode noise that the fingerprint sensor may be subjected to.

Furthermore, the charge amplifier may comprise reset circuitry for equalizing the feedback capacitor at times related to the transitions, perceived by the fingerprint sensor, of the sync signal from the first logical state to the second logical state or from the second logical state to the first logical state.

The fingerprint sensor according to various embodiments of the present invention may advantageously be included in a fingerprint sensing system, further comprising external circuitry for operating in relation to a device ground potential being a reference potential for the external circuitry, the external circuitry comprising a sensor voltage supply output connected to the voltage supply interface of the fingerprint sensor for providing the time-varying, in relation to the device ground potential, sensor ground potential and the supply voltage referenced to the time-varying sensor ground potential; an external communication interface connected to the sensor communication interface of the fingerprint sensor for controlling operation of the fingerprint sensor and for receiving the fingerprint pattern signal from the fingerprint sensor; and a synchronization signal output connected to the synchronization input of the fingerprint sensor for providing the above-mentioned sync signal to the fingerprint sensor. The sync signal may exhibit a substantially constant sync signal potential, relative to the device ground, the sync signal potential being sufficiently close to the second potential to be interpreted by the fingerprint sensor as a logical high when the sensor ground potential is at the first potential and as a logical low when the sensor ground potential is at the second potential. Alternatively, the sync signal may be modulated in relation to the device ground potential, as long as the sync signal potential relates to the sensor ground potential in the above way.

The “external circuitry” may be interfacing circuitry for providing an interface between the fingerprint sensor and other components comprised in an electronic device. Alternatively, the external device may be implemented in processing circuitry controlling operation of other parts of the electronic device in which the fingerprint sensor system may be included.

The synchronization signal output may, for example, be a constant voltage source referenced to the device ground potential.

The sensor voltage supply output may provide a time-varying, in relation to the device ground potential, sensor ground potential directly to a low potential input on the fingerprint sensor. Alternatively, the sensor voltage supply output may provide a time-varying potential directly to a high potential input on the fingerprint sensor, and the external circuitry may comprise one or several components for keeping the potential difference between the high potential input and the low potential input on the fingerprint sensor substantially constant. This may, for instance, be achieved using a suitable capacitor.

According to various embodiments, the external communication interface may advantageously comprise communication control circuitry connected to the sensor voltage supply output for: enabling output of signals from the external communication interface when the sensor ground potential is substantially equal to the device ground potential; and preventing output of signals from the external communication interface when the sensor ground potential deviates from the device ground potential.

The fingerprint sensing system according to embodiments of the present invention may, furthermore, advantageously be included in an electronic device, further comprising processing circuitry configured to: acquire a representation of the fingerprint pattern from the fingerprint sensing system; authenticate a user based on the representation; and perform at least one user-requested process only if the user is authenticated based on the representation. The electronic device may, for example, be a handheld communication device, such as a mobile phone or a tablet, a computer, or an electronic wearable item such as a watch or similar.

According to a second aspect of the present invention, there is provided a method of sensing a fingerprint pattern of a finger using a fingerprint sensor comprising: a plurality of sensing elements, each comprising: a protective dielectric top layer to be touched by the finger; an electrically conductive sensing structure arranged underneath the top layer; and a charge amplifier connected to the sensing structure for providing a sensing signal indicative of a change of a charge carried by the sensing structure resulting from a change in a potential difference between the finger and the sensing structure, the charge amplifier comprising: a negative input connected to the sensing structure; a positive input connected to a sensing element reference potential being substantially constant relative to a sensor ground potential; an output providing the sensing signal; a feedback capacitor connected between the negative input and the output; and at least one amplifier stage between the positive and negative inputs, and the output, wherein the charge amplifier is configured in such a way that a potential at the negative input substantially follows a potential at the positive input, such that a change in the sensing element reference potential provides the change in potential difference between the finger and the sensing structure; and read-out circuitry connected to the output of the charge amplifier of each of the sensing elements for sampling the sensing signal provided by each of the sensing elements and forming a fingerprint pattern signal based on the sampled sensing signals, wherein the method comprises the steps of: providing, to the fingerprint sensor, a time-varying sensor ground potential varying between a relatively low first potential and a relatively high second potential in relation to a device ground potential being a reference potential for external circuitry connected to the fingerprint sensor and for the finger, and a supply voltage referenced to the sensor ground potential; providing, to the fingerprint sensor, a sync signal; interpreting, by the fingerprint sensor, the sync signal to be in a first logical state when the sensor ground potential is at the first potential and in a second logical state, different from the first logical state, when the sensor ground potential is at the second potential; sampling, by the read-out circuitry, the sensing signal provided by each of the sensing elements at sampling times related to transitions, perceived by the fingerprint sensor, of the sync signal from the first logical state to the second logical state or from the second logical state to the first logical state; and forming the fingerprint pattern signal based on the sampled sensing signals.

The sync signal may advantageously exhibit a substantially constant potential in relation to the device ground potential.

Further embodiments of, and effects obtained through this second aspect of the present invention are largely analogous to those described above for the first aspect of the invention.

In summary, the present invention relates to a fingerprint sensor comprising a voltage supply interface for receiving a supply voltage; a sensor communication interface for providing the fingerprint pattern signal to external circuitry; a synchronization input for receiving a sync signal interpreted to correspond to a first logical state when the sensor ground potential is at the first potential and to a second logical state, different from the first logical state, when the sensor ground potential is at the second potential, and a plurality of sensing elements, each comprising a sensing structure. The sensing elements are configured such that the potential of the sensing structures follows the potential of the modulated fingerprint sensor ground potential, and the timing of the sampling of sensing signals from the sensing elements is based on perceived state transitions of the sync signal.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates a mobile phone comprising a fingerprint sensing system according to an example embodiment of the present invention;

FIG. 2 schematically shows the fingerprint sensing system in FIG. 1, comprising a fingerprint sensor and external circuitry;

FIG. 3 is a schematic block diagram of the fingerprint sensing system in FIG. 2;

FIGS. 4a-b are diagrams schematically illustrating the fingerprint sensor ground potential in relation to the device ground potential and logical states of the sync signal at different times for a first exemplary modulation of the fingerprint sensor ground potential in relation to the device ground potential;

FIGS. 5a-b are diagrams schematically illustrating the fingerprint sensor ground potential in relation to the device ground potential and logical states of the sync signal at different times for a second exemplary modulation of the fingerprint sensor ground potential in relation to the device ground potential;

FIG. 6 schematically illustrates control of sensing element and read-out circuitry in the fingerprint sensor in FIG. 3 using the sync signal received from the external circuitry;

FIGS. 7a-b are graphs schematically illustrating the relation between the fingerprint sensor ground potential and the sensing signal output by a sensing element, as well as exemplary sampling times;

FIG. 8a is a schematic cross-section view of a portion of the fingerprint sensor in FIG. 2; and

FIG. 8b is an enlargement of a part of the cross-section view in FIG. 8a schematically illustrating an exemplary structural configuration of a sensing element comprised in the fingerprint sensor in more detail.

### DETAILED DESCRIPTION OF EXAMPLE EMBODIMENTS

In the present detailed description, various embodiments of the fingerprint sensing device and method according to the present invention are mainly described with reference to a fingerprint sensing system comprising a fingerprint sensor and interface circuit for modulating the sensor ground potential in relation to the device ground potential and for handling communication between the fingerprint sensor and processing circuitry comprised in the electronic device in which the fingerprint sensing system is included. Moreover, the fingerprint sensor is illustrated as a touch sensor dimensioned and configured to acquire a fingerprint representation from a stationary finger.

It should be noted that this by no means limits the scope of the present invention, which equally well includes, for example, a fingerprint sensing system in which the circuitry for modulating the sensor ground potential in relation to the device ground potential and for handling communication with the fingerprint sensor is comprised in the processing circuitry of the electronic device. Other sensor configurations, such as a so-called swipe sensor (or line sensor) for acquiring a fingerprint representation from a moving finger, are also within the scope of the present invention as defined by the appended claims.

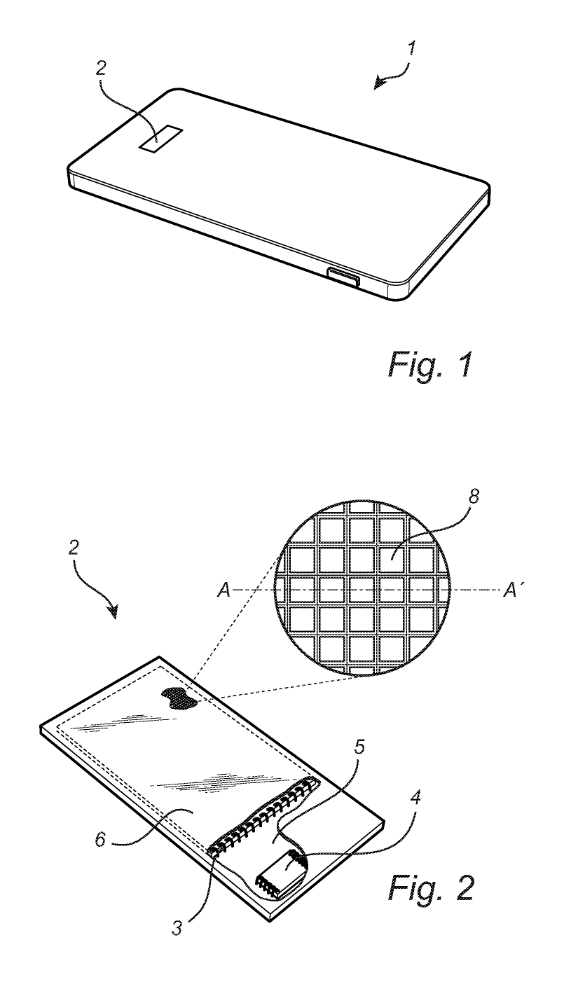

FIG. 1 schematically illustrates an application for a fingerprint sensing device according to an example embodiment of the present invention, in the form of a mobile phone 1 with an integrated fingerprint sensing system 2. The fingerprint sensing system 2 may, for example, be used for unlocking the mobile phone 1 and/or for authorizing transactions carried out using the mobile phone, etc.

FIG. 2 schematically shows the fingerprint sensing system 2 comprised in the mobile phone 1 in FIG. 1. As can be seen in FIG. 2, the fingerprint sensing system 2 comprises a fingerprint sensor 3 and an interface circuit 4. The fingerprint sensor 3 and the interface circuit 4 are arranged on the same substrate 5 and are covered by a protective coating 6. For instance, the fingerprint sensor 3 and the interface circuit 4 may be overmolded by a suitable polymer used in the electronics packaging industry.

The fingerprint sensor 3 comprises a large number of sensing elements 8 (only one of the sensing elements has been indicated with a reference numeral to avoid cluttering the drawing), each being controllable to sense a distance between a sensing structure (top plate) comprised in the sensing element 8 and the surface of a finger contacting the top surface of the fingerprint sensor 3.

The fingerprint sensor 3 in FIG. 2 may advantageously be manufactured using CMOS technology, but other techniques and processes may also be feasible. For instance, an insulating substrate may be used and/or thin-film technology may be utilized for some or all process steps needed to manufacture the fingerprint sensor 3.

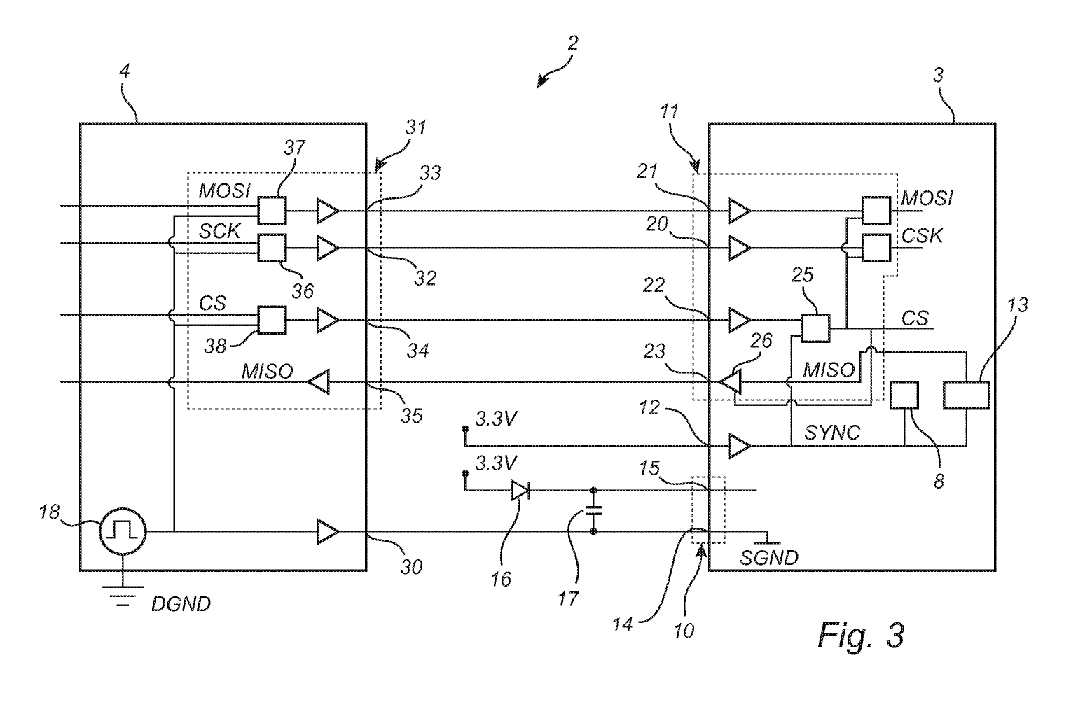

With reference to FIG. 3, which is a schematic block diagram of the fingerprint sensing system 2 in FIG. 2, the fingerprint sensor 3 comprises a voltage supply interface 10, a sensor communication interface 11, a synchronization input 12, a plurality of sensing elements 8, and read-out circuitry 13.

As is schematically illustrated in FIG. 3, the voltage supply interface 10 comprises a first input 14 and a second input 15. The first input 14 is connected to the interface circuit 4 and receives a time-varying, in relation to the device ground potential DGND, sensor ground potential SGND. The second input 15 is connected to voltage supply circuitry configured to substantially maintain a constant potential difference (supply voltage) between the first input 14 and the second input 15. In the presently illustrated example, the voltage supply circuitry comprises a diode 16 and a capacitor 17. The diode 16 is connected between a constant, in relation to the device ground potential DGND, “high” potential and the second input 15, and the capacitor 17 is connected between the first input 14 and the second input 15.

In the exemplary fingerprint sensing system 2 illustrated in FIG. 3, the AC voltage source 18 generates a square wave signal alternating between a relatively low first potential (here 0 V) and a relatively high second potential (here 3.3 V) in relation to the device ground potential DGND. This square wave signal is provided to the first input 14 of the fingerprint sensor 3 as the sensor ground potential SGND, which thus alternates between the relatively low first potential (0 V) and the relatively high second potential (3.3 V).

When the potential at the first input 14 is 0 V, the potential at the second input 15 is kept at 3.3 V by the connection, through the diode 16, with the constant “high” potential (indicated by 3.3 V in FIG. 2). When the potential at the first input 14 is 3.3 V, the diode 16 prevents current from flowing away from the second input 15, and the potential at the second input 15 is raised to 6.6 V (in relation to the device ground potential DGND) by means of the capacitor 17 keeping the potential difference between the first input 14 and the second input 15 substantially constant at 3.3 V.

It should be noted that the device ground potential DGND is a reference potential for the interface circuit 4, for a finger placed on the top of the fingerprint sensor 3, as well as for the electronic device 1 in which the fingerprint sensing system 2 is included.

In the exemplary fingerprint sensing system 2 in FIG. 3, the sensor communication interface 11 is illustrated as a simplified SPI (serial peripheral interface) port comprising a serial clock input (SCK) 20, a master output slave input (MOSI) 21, a slave select input (CS) 22; and a master input slave output (MISO) 23.

The synchronization input 12 is connected to a constant potential (here 3.3 V) in relation to the device ground potential DGND, and thus receives a sync signal SYNC exhibiting a substantially constant sync signal potential relative to the device ground potential DGND. Since the sensor ground potential SGND alternates between 0 V and 3.3 V in relation to the device ground potential DGND, the sync signal potential will alternately be +3.3 V and 0 V in relation to the sensor ground potential SGND. Accordingly, the sync signal SYNC will be interpreted by the fingerprint sensor 3 to correspond to a first logical state (high, ‘1’) when the sensor ground potential SGND is 0 V in relation to the device ground potential DGND, and to a second logical state (low, ‘0’) when the sensor ground potential SGND is 3.3 V in relation to the device ground potential DGND.

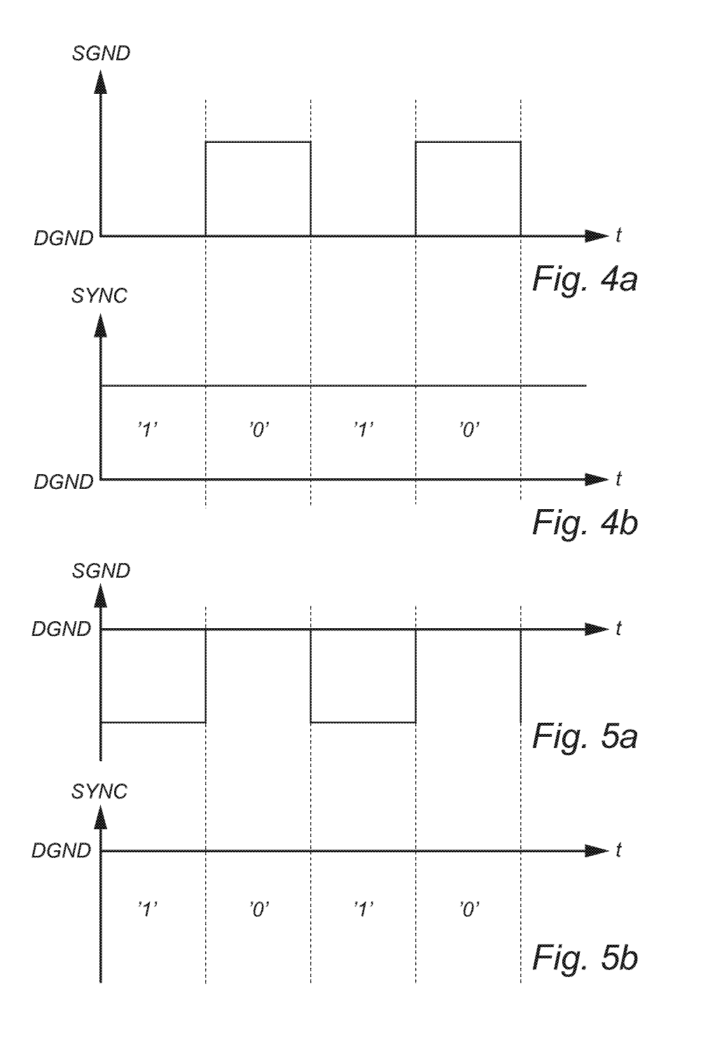

This case, with the device ground potential DGND being substantially equal to the first relatively low potential of the sensor ground potential SGND, is schematically illustrated in FIGS. 4a-b. FIG. 4a schematically shows the sensor ground potential SGND in relation to the device ground potential DGND as a function of time. FIG. 4b schematically shows the sync signal potential SYNC in relation to the device ground potential DGND as a function of time. It is also shown in FIG. 4b how the sync signal will be interpreted by the fingerprint sensor 3 depending on the sensor ground potential SGND in relation to the device ground potential DGND.

Another case, with the device ground potential DGND being substantially equal to the second relatively high potential of the sensor ground potential SGND, is schematically illustrated in FIGS. 5a-b. FIG. 5a schematically shows the sensor ground potential SGND in relation to the device ground potential DGND as a function of time. FIG. 5b schematically shows the sync signal potential SYNC in relation to the device ground potential DGND as a function of time. It is also shown in FIG. 5b how the sync signal will be interpreted by the fingerprint sensor 3 depending on the sensor ground potential SGND in relation to the device ground potential DGND.

Referring again to FIG. 3, the sensor communication interface 11 comprises communication control circuitry for controlling communication between the fingerprint sensor 3 and the interface circuit 4. In the example configuration illustrated in FIG. 3, the communication control circuitry comprises input gating circuitry for controlling signals input to the fingerprint sensor 3, and output gating circuitry for controlling signals output by the fingerprint sensor 3.

Referring to FIG. 3, input gating circuitry 25 is connected to the slave select input 22 and to the synchronization input 12. The input gating circuitry 25 will only allow the input signal at the slave select input 22 to pass the input gating circuitry 25 when the sync signal is interpreted by the fingerprint sensor as a logical high, that is, when the sensor ground potential is at 0 V. The input gating circuitry may, for example, be realized using one or several logical gates, or so-called three-state logic.

Referring again to FIG. 3, output gating circuitry 26 is connected to the read-out circuitry 13 (via an SPI-controller not shown in FIG. 3) and to the synchronization input. The output gating circuitry 26 will ensure that the potential at the output 23 will substantially not exceed 3.3 V in relation to the device ground potential DGND, by keeping the output at ‘0’ when the sync signal is ‘0’ (corresponding to the sensor ground potential SGND being 3.3 V in relation to the device ground potential DGND). The output gating circuitry may, for example, be realized using one or several logical gates, or so-called three-state logic. In FIG. 3, the output gating circuitry is schematically illustrated as a three state buffer 26.

As is schematically shown in FIG. 3, the interface circuit 4 comprises a sensor voltage supply output 30, and an external communication interface 31. Corresponding to the previously described sensor communication interface 11, the external communication interface 31 comprises a serial clock output 32, a MOSI-output 33, a CS-output 34, and a MISO-input 35.

As is indicated in FIG. 3, the external communication interface 31 further comprises communication control circuitry including NAND-gates 36, 37 and 38, in the exemplary embodiment of FIG. 3, for ensuring that signals are only transmitted to the sensor communication interface 11 of the fingerprint sensor 3 when the sensor ground potential SGND is at least substantially equal to the device ground potential DGND. It should be understood that the NAND-gates 36, 37 and 39 are only examples of suitable circuitry, and it will be straightforward for one of ordinary skill in the art to substitute one or several of the NAND-gates 36, 37 and 38 with other circuitry performing the desired function of only transmitting to the sensor communication interface 11 of the fingerprint sensor 3 when the sensor ground potential SGND is at least substantially equal to the device ground potential DGND.

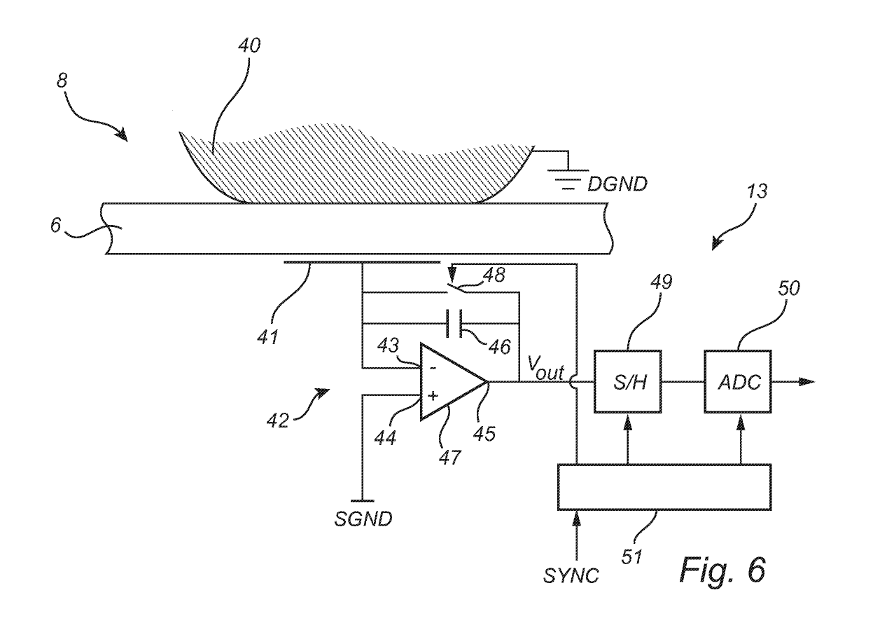

In FIG. 3, it is schematically indicated that the synchronization input 12 is additionally connected to the sensing elements 8 and to the read-out circuitry 13 for controlling the timing of sensing and sampling, as will be described in greater detail below with reference to FIG. 6.

FIG. 6 is a hybrid of a partly structural and partly circuit schematic illustration of the sensing element 8 in FIG. 2 and FIG. 3 and also schematically shows the read-out circuitry 13 in FIG. 3.

Referring to FIG. 6, the sensing element 8 comprises a protective dielectric top layer 6 to be touched by a finger 40 (FIG. 6 schematically shows a cross-section of a single ridge of a finger pattern), an electrically conductive sensing structure (plate) 41, and a charge amplifier 42. The charge amplifier 42 comprises a negative input 43, a positive input 44, an output 45, a feedback capacitor 46, and an amplifier 47.

The negative input 43 is connected to the sensing structure (plate) 41, the positive input 44 is connected to the sensor ground potential SGND and the output 45 is connected to the read-out circuitry 13.

The feedback capacitor 46 is connected between the negative input 43 and the output 45 and defines the amplification of the charge amplifier 42.

Since the charge amplifier is configured in such a way that a potential at the negative input substantially follows a potential at the positive input (so-called virtual ground), the potential at the sensing structure (plate) 41 will substantially follow the sensor ground potential SGND. Since the potential of the finger 40 is substantially constant in relation to the device ground potential DGND (for example through an electrical connection between the electronic device and the hand of the user), the variation over time of the sensor ground potential SGND in relation to the device ground potential DGND will result in a change in potential difference between the finger 40 and the sensing structure 41, which will in turn result in a change of the charge carried by the sensing structure 41 that is indicative of the capacitive coupling between the finger 40 and the sensing structure (plate) 41. The sensing signal Vₒᵤₜ provided at the output 45 of the charge amplifier 42 will be indicative of this change of charge carried by the sensing structure 41 and thus of the local capacitive coupling between the finger 40 and the sensing structure 41.

Between sensing operations, the feedback capacitor 46 needs to be reset (the charge across the feedback capacitor 46 is equalized). This is carried out using a reset switch 48.

To enable output from the fingerprint sensor 3 of a fingerprint pattern signal indicative of the fingerprint pattern of the finger 40, the sensing signal Vₒᵤₜ at the output 45 of the charge amplifier 42 is sampled and converted to digital form by the read-out circuitry 13.

As is schematically shown in FIG. 6, the read-out circuitry 13 comprises at least one sample-and-hold circuit (S/H-circuit) 49 and an analog-to-digital converter (ADC) 50.

At least the operation of the reset switch 48 and the sampling of the sensing signal Vₒᵤₜ need to be synchronized with changes of the sensor ground potential SGND in relation to the device ground potential DGND. To that end, the sync signal is connected to the sensing element 8 and to the read-out circuitry 13 via timing circuitry, schematically indicated by the box 51 in FIG. 6. Through the timing circuitry 51, the timing of the operation of the reset switch 48 as well as the sampling of the sensing signal Vₒᵤₜ by the S/H-circuit 49 (and optionally the A/D-conversion of the sampled sensing signals) is related to transitions between logical states, perceived by the fingerprint sensor 3, of the sync signal SYNC.

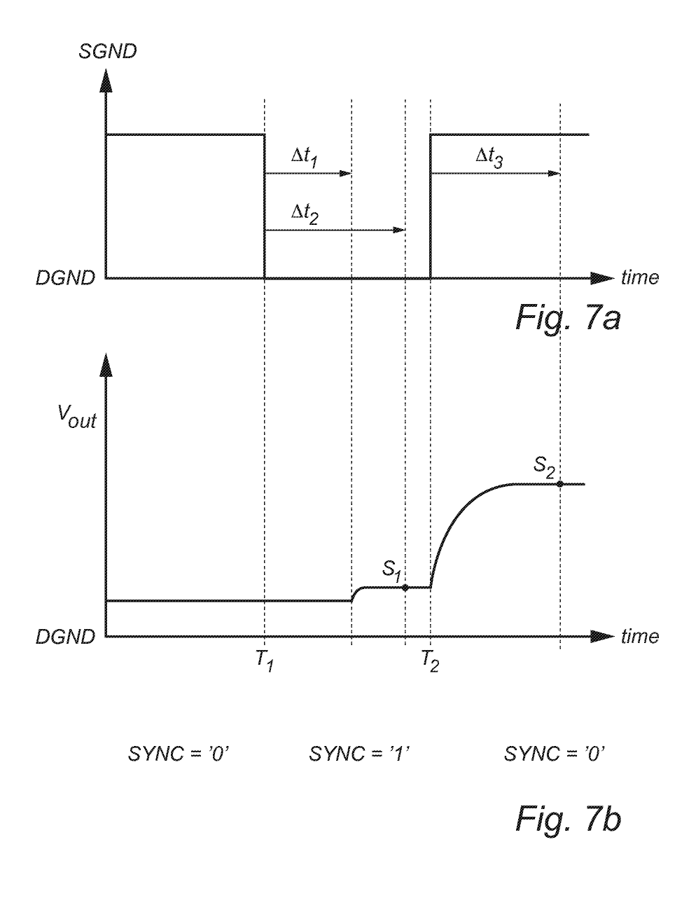

An exemplary timing relation between transitions between logical states, as perceived by the fingerprint sensor 3, of the sync signal SYNC and operation of the reset switch 48 and sampling of the sensing signal Vₒᵤₜ using the S/H circuit 49 will be described below with reference to FIGS. 7a b.

FIG. 7a shows the sensor ground potential SGND in relation to the device ground potential DGND. As described above, the potential of the sensing structure 41 in relation to the device ground potential DGND will exhibit substantially the same behavior, and FIG. 7b schematically shows the sensing signal Vₒᵤₜ.

Referring first to FIG. 7a, the sensor ground potential SGND goes from high to low potential, in relation to the device ground potential DGND, at T₁, and then goes back from low to high at T₂. At the first transition (at T₁), the SYNC-signal goes from a logical low (‘0’) to a logical high (‘1’) and at the second transition (at T₂), the SYNC-signal goes back to logical low (‘0’).

The first transition, at T₁, of the SYNC-signal is used by the timing circuitry 51 as a reference for a first delay Δt₁ for operating the reset switch 48 to bring the charge amplifier 42 to such a state (non-conducting state) that the output indicates a signal if the charge on the sensing plate 41 changes, and a second delay Δt₂ for sampling the sensing signal a first time, resulting in a first sampled value S1.

When the sensor ground potential SGND goes from low to high at T₂, there will be a change in the charge on the sensing plate 41 resulting from capacitive coupling with the finger 40. This change in charge is translated into a change in the voltage provided by the charge amplifier, that is, a change in the sensing signal Vₒᵤₜ.

The second transition, at T₂, of the SYNC-signal is used by the timing circuitry 51 as a reference for a third delay Δt₃ for sampling the sensing signal a second time, resulting in a second sampled value S2. The difference between S2 and S1 is a measure indicative of the capacitive coupling between the sensing plate 41 and the finger 40.

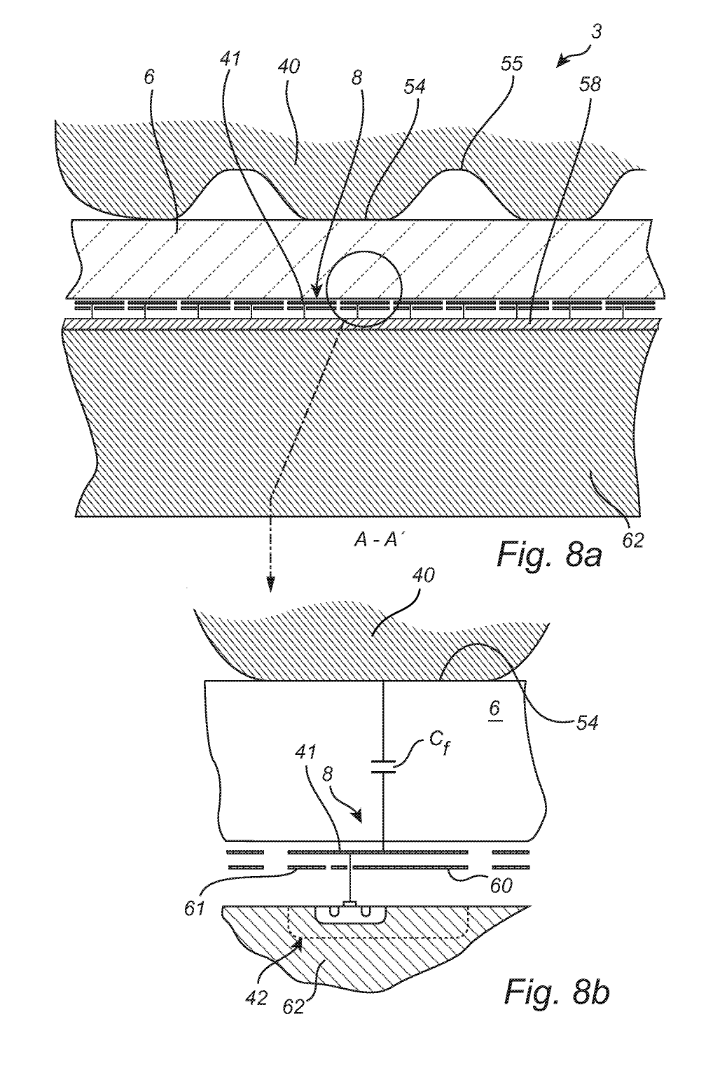

An example configuration of the sensing elements 8 will be described in more detail below with reference to FIGS. 8a b.

FIG. 8a is a schematic cross section of a portion of the fingerprint sensing sensor 3 in FIG. 2 taken along the line A-A′ as indicated in FIG. 2 with a finger 40 placed on top of the sensor. Referring to FIG. 8a, the fingerprint sensor 3 comprises a doped semiconductor substrate 62, the plurality of sensing elements 8 formed on the semiconductor substrate 62, and a protective coating 6 on top of the sensing elements. The surface of the finger 40 comprises ridges 54 that are in contact with the protective coating 6 and valleys 55 that are spaced apart from the protective coating 6.

As is schematically indicated in FIG. 8a, each sensing element 8 comprises a sensing structure in the form of a sensing plate 41 adjacent to the protective coating 6. Below the sensing plate 41 are additional metal structures and active semiconductor circuitry schematically indicated by the hatched region 58 in FIG. 8a.

As is schematically indicated in FIG. 8b, the sensing element 8 comprises, in addition to the sensing plate 41, a shielding plate 60, a reference plate 61, and a charge amplifier 42. The charge amplifier 42 is, in FIG. 8b, only very schematically indicated by the dotted line. The only part of the charge amplifier 42 that is shown in some detail is the sense transistor (MOSFET) (single stage amplifier 47 in FIG. 6) to which the sensing plate 41 is connected.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

What is claimed is:

1. A fingerprint sensor for sensing a fingerprint pattern of a finger and providing a fingerprint pattern signal indicative of the fingerprint pattern to external circuitry, said fingerprint sensor comprising:
a voltage supply interface for receiving a supply voltage referenced to a time-varying sensor ground potential, said sensor ground potential varying between a relatively low first potential and a relatively high second potential in relation to a device ground potential being a reference potential for said external circuitry and for said finger;
a sensor communication interface for receiving signals from said external circuitry and for providing said fingerprint pattern signal to said external circuitry;
a synchronization input for receiving from said external circuitry a sync signal exhibiting a substantially constant sync signal potential, relative to said device ground potential, said sync signal potential being sufficiently close to said second potential to be interpreted by said fingerprint sensor to correspond to a first logical state when said sensor ground potential is at said first potential and to a second logical state, different from the first logical state, when said sensor ground potential is at said second potential;
a plurality of sensing elements, each comprising:
a protective dielectric top layer to be touched by said finger;
an electrically conductive sensing structure arranged underneath said top layer; and
a charge amplifier connected to said sensing structure for providing a sensing signal indicative of a change of a charge carried by said sensing structure resulting from a change in a potential difference between said finger and said sensing structure, said charge amplifier comprising:
a negative input connected to said sensing structure;
a positive input connected to a sensing element reference potential being substantially constant relative to said time-varying sensor ground potential;
an output providing said sensing signal;
a feedback capacitor connected between said negative input and said output; and
at least one amplifier stage between said positive and negative inputs, and said output,
wherein said charge amplifier is configured in such a way that a potential at said negative input substantially follows a potential at said positive input, such that said sensing element reference potential provides said change in potential difference between said finger and said sensing structure; and
read-out circuitry connected to said synchronization input, and to the output of the charge amplifier of each of said sensing elements for sampling said sensing signal provided by each of said sensing elements at sampling times related to transitions, perceived by said fingerprint sensor, of said sync signal from said first logical state to said second logical state or from said second logical state to said first logical state, and forming said fingerprint pattern signal based on said sampled sensing signals.

2. The fingerprint sensor according to claim 1, wherein one of said first potential and said second potential is substantially equal to said device ground potential.

3. The fingerprint sensor according to claim 2, wherein said sensor communication interface comprises communication control circuitry connected to said synchronization input for:
enabling communication between said fingerprint sensor and said external circuitry through the sensor communication interface when said sync signal is interpreted by said fingerprint sensor to be in one of said first logical state and said second logical state corresponding to said sensor ground potential being substantially equal to said device ground potential; and
preventing communication between said fingerprint sensor and said external circuitry through the sensor communication interface when said sync signal is interpreted by said fingerprint sensor to be in the other one of said first logical state and said second logical state.

4. The fingerprint sensor according to claim 3, wherein:
said communication circuitry comprises at least one communication input for receiving signals from said external circuitry; and
said communication control circuitry comprises input gating circuitry connected to said communication input and to said synchronization input for preventing signals from said external circuitry provided to said communication input from passing said input gating circuitry when said sync signal is interpreted by said fingerprint sensor to be in one of said first logical state and said second logical state corresponding to said sensor ground potential deviating from said device ground potential.

5. The fingerprint sensor according to claim 3, wherein:
said communication circuitry comprises at least one communication output for providing the fingerprint pattern signal to said external circuitry; and
said communication control circuitry comprises output gating circuitry connected to said read-out circuitry and to said synchronization input for providing, when said sync signal is interpreted by said fingerprint sensor to be in a logical state corresponding to said sensor ground potential deviating from said device ground potential, an output signal representing said logical state.

6. The fingerprint sensor according to claim 1, wherein said fingerprint sensor is an SPI (Serial Peripheral Interface) slave, and said sensor communication interface is an SPI port comprising:
a serial clock input;
a master output slave input;
a slave select input; and
a master input slave output.

7. The fingerprint sensor according to claim 1, wherein said read-out circuitry comprises sampling circuitry for sampling said sensing signals a first time when said sync signal is interpreted by said fingerprint sensor to be in one of said first logical state and said second logical state, and a second time when said sync signal is interpreted by said fingerprint sensor to be in the other one of said first logical state and said second logical state.

8. The fingerprint sensor according to claim 1, wherein said charge amplifier comprises reset circuitry for equalizing said feedback capacitor at times related to said transitions, perceived by said fingerprint sensor, of said sync signal from said first logical state to said second logical state or from said second logical state to said first logical state.

9. A fingerprint sensing system comprising:
a fingerprint sensor according to claim 1; and
external circuitry for operating in relation to a device ground potential being a reference potential for said external circuitry, said external circuitry comprising:
a sensor voltage supply output connected to the voltage supply interface of said fingerprint sensor for providing said time-varying, in relation to said device ground potential, sensor ground potential and said supply voltage referenced to the time-varying sensor ground potential;
an external communication interface connected to the sensor communication interface of said fingerprint sensor for controlling operation of said fingerprint sensor and for receiving said fingerprint pattern signal from said fingerprint sensor; and
a synchronization signal output connected to the synchronization input of said fingerprint sensor for providing said sync signal exhibiting a substantially constant sync signal potential, relative to said device ground, said sync signal potential being sufficiently close to said second potential to be interpreted by said fingerprint sensor as a logical high when said sensor ground potential is at said first potential and as a logical low when said sensor ground potential is at said second potential.

10. The fingerprint sensing system according to claim 9, wherein said external communication interface comprises communication control circuitry connected to said sensor voltage supply output for:
enabling output of signals from said external communication interface when said sensor ground potential is substantially equal to said device ground potential; and
preventing output of signals from said external communication interface when said sensor ground potential deviates from said device ground potential.

11. An electronic device comprising:
the fingerprint sensing system according to claim 9; and
processing circuitry configured to:
acquire a representation of said fingerprint pattern from the fingerprint sensing system;
authenticate a user based on said representation; and
perform at least one user-requested process only if said user is authenticated based on said representation.

12. A method of sensing a fingerprint pattern of a finger using a fingerprint sensor comprising:
a plurality of sensing elements, each comprising:
a protective dielectric top layer to be touched by said finger;
an electrically conductive sensing structure arranged underneath said top layer; and
a charge amplifier connected to said sensing structure for providing a sensing signal indicative of a change of a charge carried by said sensing structure resulting from a change in a potential difference between said finger and said sensing structure, said charge amplifier comprising:
a negative input connected to said sensing structure;
a positive input connected to a sensing element reference potential being substantially constant relative to a sensor ground potential;
an output providing said sensing signal;
a feedback capacitor connected between said negative input and said output; and
at least one amplifier stage between said positive and negative inputs, and said output,
wherein said charge amplifier is configured in such a way that a potential at said negative input substantially follows a potential at said positive input, such that a change in said sensing element reference potential provides said change in potential difference between said finger and said sensing structure; and
read-out circuitry connected to the output of the charge amplifier of each of said sensing elements for sampling said sensing signal provided by each of said sensing elements and forming a fingerprint pattern signal based on said sampled sensing signals,
wherein said method comprises the steps of:
providing, to said fingerprint sensor, a time-varying sensor ground potential varying between a relatively low first potential and a relatively high second potential in relation to a device ground potential being a reference potential for external circuitry connected to said fingerprint sensor and for said finger, and a supply voltage referenced to said sensor ground potential;
providing, to said fingerprint sensor, a substantially constant, in relation to said device ground potential, sync signal;
interpreting, by said fingerprint sensor, said sync signal to be in a first logical state when said sensor ground potential is at said first potential and in a second logical state, different from the first logical state, when said sensor ground potential is at said second potential;
sampling, by said read-out circuitry, said sensing signal provided by each of said sensing elements at sampling times related to transitions, perceived by said fingerprint sensor, of said sync signal from said first logical state to said second logical state or from said second logical state to said first logical state; and
forming said fingerprint pattern signal based on said sampled sensing signals.
